(19) United States
(12) Patent Application Publication
(10) Pub. No.: US 2004/0249001 A1
(43) Pub. Date: Dec. 9, 2004

(54) Process for the solution recovery of nylon with high reactivity and articles made therefrom

(76) Inventor: Christian Leboeuf, Kingston (CA)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/860,353

(22) Filed: Jun. 3, 2004

Related U.S. Application Data
(60) Provisional application No. 60/476,679, filed on Jun. 6, 2003.

(51) Int. Cl. C08J 11/04

(52) U.S. Cl. 521/40

(57) ABSTRACT

A process is disclosed for the solution recovery of nylons from various post-industrial and post-consumer products, and in which the relative viscosity of the resulting polymer is effectively managed. The process includes contacting the waste products with hexamethylene diamine (alone or in monocarbamate form) and in a suitable solvent in a reactor. This is followed by dissolution and depolymerization of the polyamide material; separation of insoluble materials therefrom from the solution; recovery of the depolymerized polyamide from the separated solution; and repolymerization of the depolymerized polyamide. Articles formed using this process are also disclosed.

### CROSS REFERENCE TO RELATED APPLICATIONS

This application claims the benefit of U.S. Provisional Application No. 60/476,679 filed Jun. 6, 2003.

### FIELD OF THE INVENTION

The present invention is directed to a technique for rebalancing the polymer ends of post-consumer nylons so that these materials have high, useful relative viscosities restored. More particularly, the present invention is directed to post-treatment steps associated with nylon reclamation processes, together with useful articles formed thereby.

### BACKGROUND OF THE INVENTION

Presently there is considerable interest in recovering or recycling nylon polymer from a variety of post-industrial and post-consumer sources. Such technology offers responsible management of natural resources and extends the useful life of polymeric materials. A variety of approaches have been considered or are under review, ranging from simple mechanical separations and remelt operations to more sophisticated chemical depolymerizations with monomer recovery steps.

Published PCT Application WO 01/94457 is directed to the use of a solvent to dissolve the nylon polymer, followed by filtration of the resulting solution to remove the non-nylon components and then recover the polymer. The instant invention represents an improvement over this technique, in that it additionally rebalances polymer end groups so that the end product has a sufficiently high relative viscosity suitable for useful applications.

Other approaches in the field of nylon recovery focus on solution based processes, using solvents such as aliphatic alcohols, glycols, and formic, acetic, and phosphoric acids. These processes are conducted under conditions suitable to minimize any degraded or depolymerized products. However there is very little information available regarding preferred methods of filtration or their effectiveness.

In the classic sense, approaches towards polyamide reclamation can be grouped into “mechanical” and “nonmechanical” means. Mechanical means, such as grinding and crushing, are known means for separation of solid polyamide material from foreign materials such as carpet backing, etc. Mechanical separation yields a low grade recycled product with limited uses. In order to produce a high-quality recycled polyamide product, the process must remove impurities such as dyes, cotton thread, delusterants (TiO₂), dirt, and oil, among other things, that cannot be removed by mechanical means alone.

Among available non-mechanical approaches are those directed to isolation of the polymer. Polyamides are soluble in selected solvents, and thus solution-based processes offer routes to the recycle and recovery of polyamides. Suitable solvents are polar and often reactive with the nylon. From a processing point of view, ideal solvents should have the following characteristics: environmental friendliness, cost-effectiveness, low toxicity, capability of dissolving polyamides at relatively low temperatures, and capability of inducing polyamide precipitation for subsequent separation from the solvent. As an additional consideration in solvent-based recycle and recovery of nylon, a single solvent system rather than a mixture or a solution is generally desired as a cost effective and easier to operate system.

Certain polyols and carboxylic acids have many attributes of ideal solvents for polyamide recycle and recovery. However, polyols and carboxylic acids have not been attractive solvents because they are reactive with polyamides, and thereby have contributed to the degradation of molecular weight of the polyamide. In these prior art processes, slight losses in molecular weight have been tolerated, however, it has been thought that more significant degradation is to be avoided because recovered degraded polyamides are unsuitable for either extrusion purposes (e.g. fibers and films) or use as molding compounds.

As mentioned above, other known solvent-based recycle and recovery processes use carboxylic acid based solvents such as acetic acid and water, or glycols such as ethylene glycol and propylene glycol. Glycol-based solvent processes take advantage of the different solvencies of nylon 6 and nylon 66 at particular temperatures to separate one from the other. However, glycols also react with the polyamides, in this case to create higher molecular weight polyamides. Thus, the residence time, i.e. the time that the polyamide is contacted with the solvent must be short to avoid glycol reaction with the polyamide.

Moreover, aliphatic alcohols have been suggested for use as solvents in processes to recycle and recover polyamides. Methanol, in particular, has been shown to be useful in the separation of nylon 6 from nylon 66. Aliphatic alcohol solvents are effective under mild conditions, i.e. low temperature and short residence time.

However, for certain sources of waste nylon, the end-use conditions over the life of the article have substantially degraded the base polymer. In those cases, typical recovery techniques as illustrated above produce a polymer that has very little use because of its poor balance of reactive ends (i.e. balance of amine ends and acid ends). Subsequent solid phase polymerization or reactive extrusion steps fail to restore the polymer molecular weight from this condition, leaving a product of little if any use.

Altogether the range of raw materials useful in nylon reclamation initiatives (that is, product that has been discarded by the consumer) is very broad. Aliphatic polyamides, particularly nylon 6 and nylon 66, are extensively used in a variety of industrial and consumer products such as carpets and automotive parts. In particular, carpets and automobile air bags contain large portions of polymers with high polyamide content. Because of the great quantity of post-industrial and post-consumer nylon made available each year, these nylon products are ideal for recovery and recycle. Additionally, concerns over efficient resource utilization and environmental protection have created a need for the recovery and recycle of nylon from discarded post-industrial and post-consumer products.

An object of the present invention is to rebalance the reactive ends of the post-consumer nylon through the addition of a diamine (can be added in the form of its derivatives, in particular its carbamate form) to the solutioning reactor. A further object of the invention is the production of recovered post-consumer nylon capable of achieving high relative viscosities with post-treatment like Solid Phase Polymerization (SPP) or reactive extrusion. A feature of the invention is its ability to restore the molecular weight of reclaimed polyamides, earlier reduced during processing by aggressive pressure and temperature conditions. An advantage of the present invention is that it is readily incorporated into nylon reclamation processes. These and other objects, features, and advantages of the invention will become more apparent upon having reference to the following description of the invention.

### SUMMARY OF THE INVENTION

There is disclosed and claimed herein a process for the solution recovery of polyamides with high reactivity from post-industrial and post-consumer products comprising:

(a) contacting the post-industrial and post-consumer products containing polyamide material and insoluble material with about 0.1-4 weight percent of aliphatic diamine or a derivative thereof, in suitable solvent in a reactor;

(b) dissolving and partially depolymerizing the polyamide material in said solvent to form a solution by operating the reactor at a temperature of 135-200 C and a pressure of 350-600 psig and for a time of 0.5 -4 hours, sufficient to decrease the average molecular weight of the depolymerized polyamide to between 45% and 90% of the initial average molecular weight;

(c) separating the insoluble material from the solution;

(d) recovering the depolymerized polyamide from the separated solution; and

(e) repolymerizing the depolymerized polyamide to a repolymerized polyamide having a relative viscosity greater than or equal to 30.

The invention will become better understood upon having reference to the drawing herein.

### BRIEF DESCRIPTION OF THE DRAWINGS

FIG. 1 is a flow chart illustrating the steps in the process of the present invention.

### DETAILED DESCRIPTION OF THE INVENTION

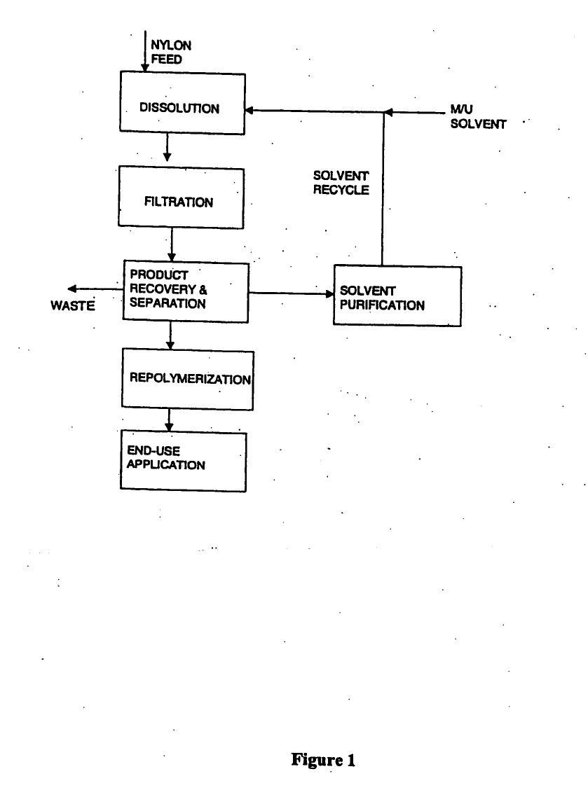

The process as illustrated in FIG. 1 comprises five main steps, as follows:

Step 1: Contacting the polyamide-containing post-industrial and post-consumer product an aliphatic diamine, preferably a C4-C6 diamine, and most preferably hexamethylene diamine, or a rerivative of the diamine, preferably the diamine monocarbamate in solvent (preferably methanol).

Step 2: Dissolving and partially depolymerizing the polyamide in the selected solvent under controlled conditions of temperature, pressure and residence time, to decrease the average molecular weight of the polyamide to between 45% and 90% of its original average molecular weight.

Step 3: Filtering the solution to remove solid impurities.

Step 4: Recovering the depolymerized polyamide from the solution.

Step 5: Repolymerizing the depolymerized polyamide so that it has a certain minimum relative viscosity and can be used to make other useful products.

In Step 1, nylon-containing post-industrial and post-consumer products are collected. The majority of recyclable nylon consists of nylon 6 and nylon 66 formed by the homopolymerization of 6-aminocaproic acid, also known as e-caprolactam. Nylon 66 also known as nylon 6, 6, is the polyamide formed by the reaction of adipic acid with hexamethylenediamine.

Waste and scrap nylon 6 and nylon 66 are available from many sources including but not limited to rejects, turnings and trimmings from manufacturing processes, automotive parts, carpets, clothing, etc. The waste post-industrial and post-consumer products may be prepared for recycling by any method that produces particulate material such as grinding, crushing, etc. Alternately, if the source material is small enough, it may be used whole. Nylon fiber may be used as or may also be ground into smaller pieces. Nylon fiber in carpets may be separated from the carpet backing, i.e. by shearing.

Other nylon waste products suitable as starting materials for this invention include air intake manifolds, radiator end tanks, coated nylon fabrics, and airbag fabrics, among other products. Mineral filled nylons are also useful in the instant process.

An aliphatic diamine, preferably a C4-C6 diamine, and most preferably hexamethylene diamine, or a rerivative of the diamine, preferably the diamine monocarbamate is added to the waste products in amounts of 1-2 weight percent, which raises the level of free amine ends closer to the acid ends in the recovered polymer. This balancing of the ends kinetically enhances the condensation reaction, thus yielding polymer of higher molecular weight under post-treatment conditions(such as SPP or reactive extrusion). In this fashion the recovered polyamide displays superior polycondensation kinetics by virtue of its restored balance of reactive ends. Hexamethylene diamine e monocarbamate is the preferred material because of its ease of handling, i.e. it is a solid powder at ambient conditions. During the solutioning process, this material thermally decomposes into hexamethylene diamine and carbon dioxide.

The nylon-containing products are then contacted with methanol to dissolve and depolymerize nylon under predetermined conditions. Although methanol is the preferred solvent, other solvents may be used including other aliphatic alcohols such as ethanol. The alcohol is preferably used in an anhydrous form, but it may also be in a solution of at least 90% by weight alcohol. Additionally, mixtures of ethanol, methanol or water may be used as the solvent, so long as the water content is no more than 10% by weight.

In Step 2, the polyamide is dissolved and partially depolymerized in the solvent in a reactor capable of operating at elevated temperatures and pressures. The temperature of the reactor is elevated and pressure is increased to maintain a liquid phase. Sufficient residence time is needed to allow sufficient depolymerization of the polyamide to occur. That is, the polyamide must dissolve and be at least partially depolymerized. For the depolymerization of nylon 6 and nylon 66, the temperature range is 135 to 200° C.; the pressure range is 350 to 600 psig; and the residence time necessary for depolymerization ranges from about 30 minutes to about 4 hours. Under these controlled conditions, depolymerization of the polyamide reduces the average molecular weight of the polyamide from between about 10% to about 75%. This results in a decrease in the viscosity of the solution. The reduced viscosity solution of polyamide with insoluble particulate (as feed impurities) is rebalanced by the addition of an aliphatic diamine, preferably a C4-C6 diamine, and most preferably hexamethylene diamine, or a derivative of the diamine, preferably the diamine monocarbamate The concentration is adjusted to allow for enough viscosity to enable proper filtration.

In Step 3, the solution containing the dissolved and depolymerized nylon, insoluble materials and any excess diamine or its derivative is passed through suitable filtration media to remove and separate the insoluble materials from the solution. Any suitable method of filtration may be used. The preferred filtration method involves passing the dissolved and depolymerized nylon solution through pressed glass fibers. In this preferred method, glass wool filtration involves passing the solution, under pressure of about 500 psig, through glass wool supported by wire mesh. Other filtration media may also be used, including glass fiber fabric, polyester fabric, and polyaramid fabric. Those of skill in the field will recognize that other fabric selections may be suitable. Throughout this filtration step, all operating conditions including temperature, pressure and solvent concentration are maintained within the above-described ranges to keep the dissolved and depolymerized nylon in solution.

This filtration step separates insoluble material including sub-micron sized particulate matter such as TiO₂, from the solution. This results in a substantially more purified, low viscosity solution containing the depolymerized nylon. Because the nylon is not only dissolved but also depolymerized, much finer solid particles can be removed than would otherwise be possible with a solution containing large, intact higher viscosity nylon polymer. Finer filtration makes possible the removal of small sized impurities such as TiO₂ that are commonly found in nylon-containing products. In addition, because the nylon to be recycled is depolymerized, greater concentrations of nylon in solvent and longer residence times in the reactor are possible while still allowing for an acceptable recovered product. This is because the depolymerized nylon has a lower viscosity than that of the original, dissolved polymerized nylon.

In Step 4, the depolymerized nylon is precipitated out and removed from the filtered solution of Step 3 by either cooling the solution or diluting the solvent with an additive that forces the nylon out of solution, such as an anti-solvent agent. Once out of solution, the depolymerized nylon is separated from the solvent by filtration or centrifugation. Residual solvent must be removed from the depolymerized nylon before repolymerization. Removing nylon from the solvent in Step 4 produces both a reduced molecular weight (depolymerized) nylon and a solvent with soluble impurities therein. The solvent may be purified by existing technology (such as distillation) as will be appreciated by those of skill in this field; and recycled back to Step 1 at the beginning of this process.

In Step 5, repolymerization of the recovered polyamide is carried out, a process in which it is subjected to suitable conditions to restore molecular weight. Repolymerization begins with low viscosity, low molecular weight polyamide and results in a higher viscosity, higher quality polyamide suitable for end-use processing. The repolymerization of nylon can be done readily by one of two standard methods: solid-phase repolymerization or melt-phase repolymerization. The choice of repolymerization method depends on the need for greater residence time, i.e. the time needed for repolymerization to occur.

The solid-phase method of repolymerizing nylon is carried out at any suitable temperature below the melting point of the polyamide. For Nylon 6, the upper temperature limit is 220° C. whereas for Nylon 66 it is 265° C. The preferred temperature range for solid-phase repolymerization is 160-200° C. Solid-phase repolymerization has no residence time limit, i.e. the repolymerization process may take as long as is needed, and therefore is used for recovery of significantly depolymerized polyamides. Solid-phase repolymerization yields a high quality, high molecular weight polyamide. In the melt-phase repolymerization method, the preferred temperature range of operation is 270-300° C. and the residence time limit for repolymerization is 1-30 minutes. Melt-phase repolymerization is a faster, simpler process compared to solid-phase repolymerization and is used if the final product to be made from the repolymerized polyamide is an extruded product.

Irrespective of the repolymerization method selected, the conditions are closely controlled to produce sufficient melt viscosity for end use applications. Once repolymerization is complete, the recycled and recovered polyamide can be manufactured into nylon-containing industrial and consumer products. These products include many in which virgin polyamide may be used.

It is readily understood and appreciated that those having skill in the art to which this invention pertains can make any number of variations and modifications to the invention as set forth and described herein. Such enhancements are contemplated as within the spirit and scope of the invention.

### EXAMPLE 1

A 4.5 L Stainless Steel reactor, mechanically stirred, is charged with 200 g of virgin radiator end tank (RET)resin pellets. The radiator end-tank resin is typically made of glass fiber-filled PA66. The process described herein is designed for the recovery of PA66, and its separation from glass fibers. Methanol (2 L) is added to the reactor, as well as 0.74%, based on the weight of RET resin, of hexamethylene diamine monocarbamate (a.k.a DIAK-1® from E.I. DuPont). The reactor is then sealed and purged with N₂for several minutes while agitating gently. The pilot plant's reactor communicates with a second vessel, the precipitator, through a 1.27 cm in diameter Stainless Steel line. Both the precipitator and the reactor have the same maximum pressure rating of 3000 psi (20.6 MPa). The reactor and the precipitator are also equipped with a heating mantle capable of heating their contents to at least 200° C. A discharge valve, located on the transfer line, below the reactor, allows transfer of the reactor contents into the precipitator. A filter bed has been placed initially at the bottom of the reactor, inside the vessel. It consists of a 200 mesh metal screen, circularly shaped to fit the bottom of the reactor. The metal screen is used to support 2 paper filters of 1μ nominal porosity. The paper filters are covered with loosely packed long glass-fiber wool. The filter, positioned at the bottom of the reactor, removes the short glass-fibers during the transfer of the methanol solution to the precipitator. The discharge valve is operated only in 2 modes: either fully opened or fully closed. The precipitator is equipped with an internal cooling coil and when required, cold water is circulated through the coil in order to “crash cool” the solution in the precipitator and to force the polymer to come out of solution. At the beginning of these experiments, the reactor and precipitator are pressurized with N₂ to 200 psi (1.37 MPa) and 500 psi (3.43 MPa) respectively.

After pressurization of the reactor and precipitator, the heat is turned on such that the reactor contents are heated to 175° C. in approximately 20 minutes, and the precipitator wall temperature is maintained at approximately 195° C. Once the reactor content has reached 175° C., it is maintained at that temperature for 60 minutes. At the end of the 1-hour hold period, the pressure in the reactor is approximately 900 psi (6.2 MPa). The pressure inside the precipitator is adjusted to be only 50 psi (0.34 MPA) lower than that of the reactor, and the discharge valve open fully to initiate filtration of the hot methanolic solution and its transfer to the precipitation tank. Once in the precipitation tank, under mechanical agitation, the solution is cooled to ambient temperature, circulating cold water in through the precipitator's cooling coil. When transfer has been completed, both vessels are at equilibrated pressures of approximately 300 psi (2.1 MPa). At that point in the process, the vessels are vented to atmosphere using the system's backpressure regulator. When the pressure in the precipitator has been equilibrated with atmospheric pressure, the agitator is turned off and the precipitator is opened. The methanolic solution is decanted, and the wet solids are dried overnight by atmospheric evaporation, followed by drying at 60° C. in a vacuum oven under −21 inches of Hg for several hours. The recovered PA66 polymer is characterized (see TABLE 1 below).

The reactivity of the recovered PA66 polymer is evaluated on a small Solid Phase Polymerization reactor by holding the powder at 180° C. under −21 inches HG of vacuum for 1, 2 and 4 hrs respectively. Product analysis can be found in TABLE 1.

### COMPARATIVE EXAMPLE 1

The same procedure as that described for EXAMPLE 1 is followed, except for the following: the feed stock is changed to PC-RET (post-consumer radiator end-tanks chopped into coarse and irregularly shaped pieces, roughly 1 cm long in their longest dimension), no hexamethylene diamine monocarbamate is added and after transfer, the methanolic solution is cooled slowly over several hours by turning the heat off to the precipitator. Product analysis can be found in TABLE 1.

### EXAMPLE 2

The same procedure as that described for EXAMPLE 1 is followed, except for the following: the feedstock is post-consumer radiator end-tanks (PC-RET), chopped into coarse and irregularly shaped pieces, roughly 1 cm long in their longest dimension, and after transfer of the filtered hot methanolic solution into the precipitator, the temperature of the contents of the precipitator is lowered to 160° C. and held at that temperature for 2 hrs. After the 2 hrs hold in the precipitator, all heat sources are turned off and the vessel and its contents are allowed to cool slowy to ambient temperature. Product analysis can be found in TABLE 1.

### EXAMPLE 3

The same procedure as that described for EXAMPLE 2 is followed, except for the following: 1.48% of HC is added to the reactor's initial charge. Product analysis can be found in TABLE 1.

### EXAMPLE 4

The same procedure as that described for EXAMPLE 2 is followed, except for the following: (i) the reactor contents are heated to 180oC and maintained at that temperature for 75 minutes before initiating transfer to the precipitator, (ii) subsequent to transfer into the precipitator, the temperature of the methanol solution is lowered to 120° C., and held at that temperature for 30 min before turning off all heat sources and allowing the precipitator to cool slowly to ambient temperature. Product analysis can be found in TABLE 1.

### EXAMPLE 5

The same process steps as EXAMPLE 4 are followed except for the following: (i) the reactor is heated to 180° C. initially and maintained at that temperature for 30 min only before initiation of the transfer to the precipitator, (i) once in the precipitator, the solution is cooled to 120° C., and held at 120° C. for 2 hours prior to initiating slow cooling to ambient temperature. Product analysis can be found in TABLE 1.

### EXAMPLE 6

The same process steps as EXAMPLE 5 are followed except for the following: the reactor is held at 180° C. for 75 minutes before initiation of the transfer to the precipitator. Product analysis can be found in TABLE 1.

### EXAMPLE 7

The same process steps as EXAMPLE 4 are followed except for the following: the reactor heated to 170oC and held at that temperature for 30 minutes before initiation of the transfer to the precipitator. Product analysis can be found in TABLE 1.

### EXAMPLE 8

The same process steps as EXAMPLE 7 are followed except for the following: once transferred to the precipitator has been completed, the temperature of the precipitator's contents is lowered to 120° C. and maintained at that temperature for 2 hrs prior to initiation of slow cooling to ambient temperature. Product analysis can be found in TABLE 1.

### EXAMPLE 9

The same process steps as EXAMPLE 8 are followed except for the following: the methanol solution is held in the reactor for 75 minutes at 170° C. before initiating transfer to the precipitator. Product analysis can be found in TABLE 1.

### EXAMPLE 10

The same process steps as EXAMPLE 9 are followed except for the following: the contents of the reactor are heated to 175oC and immediately after target temperature is reached, transfer, and filtration, are initiated. Product analysis can be found in TABLE 1.

### EXAMPLES CARRIED OUT ON LARGER DEMONSTRATION UNIT

### EXAMPLE 11

A large Stainless Steel reactor, of 1300 L capacity, mechanically stirred, is charged with 55 Kg of post-consumer radiator end tank (PC-RET), chopped into coarse and irregularly shaped pieces, roughly 1-2 cm long in their longest dimension. The radiator and-tanks are typically made of glass fiber-filled PA66. The process described herein is designed for the recovery of PA66, and its separation from glass fibers. Methanol (495 Kg or 620L) is added to the reactor, as well as 1.03%, based on the weight of PC-RET feedstock, of hexamethylene diamine monocarbamate (a.k.a DIAK-1® from E.I. DuPont). The reactor is then sealed and purged with N₂ for several minutes while agitating gently. The demonstration plant reactor communicates with a second vessel of equal size, the precipitator, through a 7.5 cm in diameter Stainless Steel line. A hot oil jacket provides the heat necessary for the operation of the reactor and precipitator. A discharge valve, located on the transfer line, below the reactor, allows transfer of the reactor contents into the precipitator. A metal basket filter, also oil jacketed and insulated, is located between the reactor and the precipitator. The filter unit has an operating volume of 100 L and its filter has a nominal porosity of 3μ. The basket filter removes the glass fiber during transfer of the methanol solution to the precipitator. The precipitator is equipped with an internal cooling coil and when required, oil is circulated through the coil in order to increase the cooling rate of the solution in the precipitator and to initiate precipitation. At the beginning of these runs, the reactor and precipitator are purged with N₂ to eliminate oxygen as much as possible, thus minimizing polymer degradation.

After pressurization of the reactor and precipitator, the heat is turned on such that the reactor content is heated to 175° C. Once the reactor content has reached 175° C., transfer/filtration is initiated immediately by adjusting a ΔP of 50 psi (0.34 MPa) between the 2 vessels. Once the transfer has been completed, the temperature inside the precipitator is adjusted to 140° C. and maintained at that temperature for 2 hours. At the end of the 2 hours, the temperature of the contents of the precipitator is lowered to ambient temperature and the pressure of the whole system is equilibrated with atmospheric pressure. The precipitated polymer forms a slurry in methanol inside the precipitator. Agitation of the slurry is maintained throughout the atmospheric filtration step, i.e. separation of polymer solids from methanol, using a vacuum belt filtration unit. The wet polymer cake discharges from the end of the belt of the filtration unit into a rotary dryer.

Once the transfer of the wet polymer cake to the dryer is complete, the bulk of the residual methanol if evaporated at 90° C., then the temperature of the hot oil jacket is increased to 175° C. The recovered PA66 is then held at 175° C. for 2 hrs, and the heat is turned off. The dry PA66 is allowed to slowly cool to ambient temperature under a N₂ blanket. Product analysis can be found in TABLE 1.

### EXAMPLE 12

Same process as for EXAMPLE 11, but the recovered PA66 is only held for 1 hr at 175° C. in the dryer. Product analysis can be found in TABLE 1.

### EXAMPLE 13

Same process as for EXAMPLE 11, but the recovered PA66 is only held for 5 hr at 175° C. in the dryer. Product analysis can be found in TABLE 1.

### EXAMPLE 14

Same process as for EXAMPLE 11, but the recovered PA66 is only held for 8.5 hours at 175° C. in the dryer. Product analysis can be found in TABLE 1.

TABLE 1

| | | REACTOR | | PRECIP. TANK | | PRECIP. | | % | SPP | | | | | |
|---|---|---|---|---|---|---|---|---|---|---|---|---|---|---|
| | | TIME | | H/U | | COOLING | | HC | TIME | T | FINAL PRODUCT | | | |
| EXAMPLES | FEED | (min) | T (° C.) | (min) | T (° C.) | CRASH | SLOW | to Rx | (hrs) | (° C.) | RV | NH₂ | CO₂H | CO₂CH₃ |
| COMPARATIVE 1 | PC-RET | 60 | 175 | 0 | — | | X | 0 | 0 | 180 | 21.9 | 44 | 7 | 143 |
| | | | | | | | | | 1 | 180 | 23.6 | 62 | 14 | 132 |
| | | | | | | | | | 2 | 180 | 24 | 63 | 8 | 120 |
| | | | | | | | | | 4 | 180 | 24.5 | 59 | 20 | 139 |
| 1 | VIRGIN | 60 | 175 | 0 | — | X | | 0.74 | 0 | 180 | 22.3 | 114 | 52 | |
| | RET | | | | | | | | 1 | 180 | 45.3 | 43 | 47 | 63 |
| | | | | | | | | | 2 | 180 | 50.3 | 36 | 42 | 62 |
| | | | | | | | | | 4 | 180 | 50.3 | 32 | 47 | 88 |
| 2 | PC-RET | 60 | 175 | 120 | 160 | | X | 0.74 | 0 | 180 | 24 | 94.5 | 15.9 | 92.8 |
| | | | | | | | | | 1 | 180 | 40.4 | 47.7 | 22 | 79.8 |
| | | | | | | | | | 2 | 180 | 41.5 | 39.2 | 26.7 | 77.8 |
| | | | | | | | | | 4 | 180 | 42.3 | 37.4 | 21.7 | 76.7 |
| 3 | PC-RET | 60 | 175 | 120 | 160 | | X | 1.48 | 0 | 180 | 24.9 | 121.3 | 46.7 | 109.8 |
| | | | | | | | | | 1 | 180 | 37.9 | 54.3 | 22.4 | 89.8 |
| | | | | | | | | | 2 | 180 | 41.5 | 41.1 | 20.9 | 86.1 |
| | | | | | | | | | 4 | 180 | 41.1 | 35.7 | 21.4 | 91 |
| 4 | PC-RET | 75 | 180 | 30 | 120 | | X | 0.74 | 0 | 180 | 20.2 | 114 | 39 | 158 |
| | | | | | | | | | 4 | 180 | 32.7 | 39 | 30 | 118 |
| 5 | PC-RET | 30 | 180 | 120 | 120 | | X | 0.74 | 0 | 180 | 24.9 | 86 | 50 | 77 |
| | | | | | | | | | 4 | 180 | 40.3 | 30 | 43 | 75 |
| 6 | PC-RET | 75 | 180 | 120 | 120 | | X | 0.74 | 0 | 180 | 21 | 98 | 35 | 162 |
| | | | | | | | | | 4 | 180 | 32.3 | 37 | 33 | 112 |
| 7 | PC-RET | 30 | 170 | 30 | 120 | | X | 0.74 | 0 | 180 | 21.4 | 81 | 54 | 56 |
| | | | | | | | | | 4 | 180 | 45.6 | 36 | 48 | 58 |
| 8 | PC-RET | 30 | 170 | 120 | 120 | | X | 0.74 | 0 | 180 | 25.7 | 92 | 43 | 93 |
| | | | | | | | | | 4 | 180 | 37.4 | 35 | 39 | 86 |
| 9 | PC-RET | 75 | 170 | 120 | 120 | | X | 0.74 | 0 | 180 | 29.2 | 80 | 44 | 110 |
| | | | | | | | | | 4 | 180 | 40.4 | 24 | 39 | 77 |
| 10 | PC-RET | 0 | 175 | 120 | 120 | | X | 0.74 | 0 | 180 | 25.8 | 107 | 45 | 98 |
| | | | | | | | | | 4 | 180 | 42.3 | 42 | 41 | 94 |
| 11 | PC-RET | 0 | 175 | 120 | 140 | X | | 1.03 | 2 | 175 | 58.6 | 56.7 | 52.3 | 38.6 |
| 12 | PC-RET | 0 | 175 | 120 | 140 | X | | 1.03 | 1 | 160 | 46 | 46 | 42 | — |
| 13 | PC-RET | 0 | 175 | 120 | 140 | X | | 1.03 | 5 | 175 | 60 | 49.6 | 55 | 33 |
| 14 | PC-RET | 0 | 175 | 120 | 140 | X | | 1.03 | 8.5 | 175 | 69.2 | 38.4 | 48.1 | 26.3 |

1. A process for the solution recovery of polyamides with high reactivity from post-industrial and post-consumer products comprising:
(a) contacting the post-industrial and post-consumer products containing polyamide material and insoluble material with about 0.1-4 weight percent of either an aliphatic diamine or a derivative thereof, in suitable solvent in a reactor;
(b) dissolving and partially depolymerizing the polyamide material in said solvent to form a solution by operating the reactor at a temperature of 135-200 C. and a pressure of 350-600 psig and for a time of 0.5 -4 hours, sufficient to decrease the average molecular weight of the depolymerized polyamide to between 45% and 90% of the initial average molecular weight;
(c) separating the insoluble material from the solution;
(d) recovering the depolymerized polyamide from the separated solution; and
(e) repolymerizing the depolymerized polyamide to a repolymerized polyamide having a relative viscosity greater than or equal to 30.

2. The process of claim 1 wherein in step (a) the solvent is an aliphatic alcohol.

3. The process of claim 2 wherein the aliphatic alcohol is methanol.

4. The process of claim 1 wherein in step (a) hexamethylene diamine monocarbamate is used.

5. The process of claim 1 wherein in step (c) the separation is conducted using filtration means selected from the group consisting of glass fibers, wire mesh, glass fiber fabric, polyester fabric, polyaramid fabric, glass wool and pressed glass fibers.

6. The process of claim 1 wherein in step (d) depolymerized polyamide is recovered from the separated solution by precipitation through either cooling the solution or diluting the solvent with an anti-solvent agent.

7. The process of claim 1 wherein in step (e) the depolymerized polyamide is repolymerized by either solid phase repolymerization or melt phase repolymerization.

8. An article made from the process of claim 1.

9. The process of claim 1 wherein the post-industrial and post-consumer products include one or more of carpet waste, chopped nylon carpet, air intake manifolds, radiator end tanks, coated nylon fabrics, air bag fabrics and mineral-filled nylon.

10. The process of claim 1 wherein in step (a) the aliphatic diamine is a C4-C6 diamine.

11. The process of claim 10 wherein in step (a) the aliphatic diamine is hexamethylene diamine.

12. The process of claim 1 wherein in step (a) the derivative of the diamine is the diamine monocarbamate
